(19) United States
(12) Patent Application Publication
(10) Pub. No.: US 2006/0233403 A1
(43) Pub. Date: Oct. 19, 2006

(54) Multi speaker unit and audio reproduction apparatus

(75) Inventor: Ryuji Nakagawa, Hamamatsu-shi (JP)

Correspondence Address: HARNESS, DICKEY & PIERCE, P.L.C., P.O. BOX 828, BLOOMFIELD HILLS, MI, 48303, US

(73) Assignee: Yamaha Corporation, Hamamatsu-shi (JP)

(21) Appl. No.: 11/405,605

(22) Filed: Apr. 17, 2006

(30) Foreign Application Priority Data
Apr. 18, 2005 (JP) JP2005-120069

(51) Int. Cl. H04R 25/00

(52) U.S. Cl. 381/182

(57) ABSTRACT

A multi speaker unit includes a permanent magnet that has a north pole and a south pole, a yoke that is opposed to the north pole and the south pole of the permanent magnet with first and second gaps, a first voice coil that is arranged in the first gap between the north pole of the permanent magnet and the yoke, a second voice coil that is arranged in the second gap between the south pole of the permanent magnet and the yoke, and first and second vibrating parts that are fixed to the first and second voice coils.

### BACKGROUND OF THE INVENTION

The present invention relates to a multi speaker unit and an audio reproduction apparatus using the same.

As generally known, a speaker includes a magnetic circuit composed of a permanent magnet and a yoke, a voice coil arranged so as to intersect with a gap provided in the magnetic circuit, and a diaphragm made of corn paper fixed to the voice coil as main components. In such type of speakers, a sound signal is energized onto a voice coil, which causes the voice coil to reciprocate. Reciprocation of the voice coil causes the diaphragm to vibrate thus emitting a sound from the diaphragm. For example, there is JP-A-2001-245387 as a reference document regarding speakers.

In order for the related speakers to obtain a high output, it is necessary to increase the magnetic flux density to be generated in the gap in the magnetic circuit. This requires larger permanent magnet and yoke. To do this, related speakers use large-sized permanent magnets and yokes to obtain a high output, which results in the increase in the size and weight of the final speaker design. In the case of an audio reproduction apparatus using a number of speakers, it is necessary to use a large-sized permanent magnet and a yoke in each of the speakers for the purpose of obtaining a high output from each of them, thus resulting in the increase in the size and weight of the apparatus.

### SUMMARY OF THE INVENTION

The invention has been accomplished in view of the aforementioned circumstances. An object of the invention is to provide a multi speaker unit that requires only small addition to the size and weight of audio reproduction apparatus as the entire apparatus when the size of the magnetic circuit in each speaker is increased to obtain a high output, and an audio reproduction apparatus using the same.

The invention provides a multi-speaker unit comprising:

a permanent magnet that has a north pole and a south pole;

a yoke that is opposed to the north pole and the south pole of the permanent magnet with first and second gaps;

a first voice coil that is arranged in the first gap between the north pole of the permanent magnet and the yoke;

a second voice coil that is arranged in the second gap between the south pole of the permanent magnet and the yoke; and

first and second vibrating parts that are fixed to the first and second voice coils respectively.

Preferably, an audio reproduction apparatus comprises a plurality of the multi speaker units.

Preferably, in the multi speaker unit, the first vibrating part is directed to a first direction opposite outward to a second direction to which the second vibrating part is directed.

Preferably, in the multi speaker unit, the first vibrating part and the second vibrating part are directed to the same direction.

Preferably, an audio reproduction apparatus comprises a plurality of the multi speaker units. The multi speaker units are arranged on a plane.

Preferably, an audio reproduction apparatus comprises a plurality of the multi speaker units. The multi speaker units are arranged on a cylindrical face.

Preferably, in the multi speaker unit, the first vibrating part is directed to a first direction. The second vibrating part is directed to a second direction. An angle formed by the first and second directions is substantially 90 degrees.

According to the present invention, there is also provided a multi speaker unit, comprising:

a permanent magnet that has a north pole and a south pole;

a yoke that is opposed to the north pole and the south pole of the permanent magnet with first and second gaps respectively;

a first voice coil that is arranged in the first gap between the north pole of the permanent magnet and the yoke;

a second voice coil that is arranged in the second gap between the south pole of the permanent magnet and the yoke; and

first and second vibrating parts that are fixed to the first and second voice coils respectively,

wherein the permanent magnet is formed in a tube shape; and

wherein the yoke is arranged inside the permanent magnet.

With the invention, two vibrating parts and two voice coils share a single magnetic circuit including a permanent magnet and a yoke. It is thus possible to reduce the increase in the size and weight of the entire multi-speaker unit even in case the size of the magnetic circuit has to be increased to deliver a high output from each vibrating part.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a cross-sectional view showing the configuration of a multi speaker unit according to a first embodiment of the invention;

FIG. 2 is a cross-sectional view showing the configuration of a multi speaker unit according to a second embodiment of the invention;

FIG. 3 is a cross-sectional view showing the configuration of a multi speaker unit according to a third embodiment of the invention;

FIG. 4 is a perspective view of the configuration of a speaker array according to a fourth embodiment of the invention;

FIG. 5 is a perspective view of the configuration of a speaker array according to a fifth embodiment of the invention;

FIG. 6 is a cross-sectional view of the configuration of a speaker array according to another embodiment of the invention; and

FIG. 7 is a cross-sectional view of the configuration of a speaker array according to another embodiment of the invention.

### DETAILED DESCRIPTION OF THE PREFERRED EMBODIMENTS

Embodiments of the invention will be described referring to drawings.

### First Embodiment

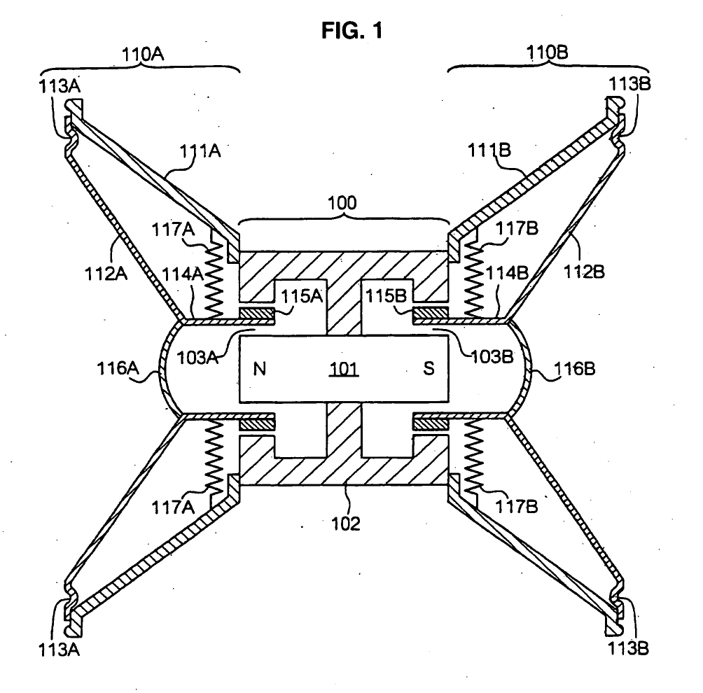

FIG. 1 is a cross-sectional view showing the configuration of a multi speaker unit according to a first embodiment of the invention. This multi-channel speaker unit is composed of speaker parts 110A, 110B and a magnetic circuit shared by these speaker parts 110A and 110B. The speaker parts 110A and 110B are fixed to a housing (not shown) in horizontal symmetry. For example, the speaker parts 110A and 110B are used as L-channel and R-channel speakers. In the speaker parts 110A and 110B, frames 111A and 111B have the shape of a corn and are fixed back to back to the housing (not shown). Diaphragms 112A and 112B are corn-shaped members. Surrounding edge parts 113A and 113B of the diaphragms 112A and 112B are fixed to the edges of the frames 111A and 111B. Cylindrical parts 114A and 114B are provide at the bottom of the diaphragms 112A and 112B. Voice coils 115A and 115B are wounded around the cylindrical parts 114A and 114B. Center caps 116A and 116B are attached to the center of the diaphragms 112A and 112B respectively. Dumper 117A is interposed between the cylindrical part 114A and the frame 111A, and dumper 117B is interposed between the cylindrical part 114B and the frame 111B to regulate the direction of vibration of the cylindrical parts 114A and 114B in respective axial directions thereof.

The magnetic circuit 100 includes a permanent magnet 101 and a cylindrical yoke 102. The cylindrical yoke 102 is opposed to the north pole and south pole of the permanent magnet 101 via gaps 103A and 103B. The voice coil 115A of the speaker part 110A is inserted into the gap 103A between the north pole of the permanent magnet 101. The voice coil 115B of the speaker part 110B is inserted into the gap 103B between the south pole of the permanent magnet 101. The voice coil 115A and the voice coil 115B are wound in opposite direction to each other. This is to bring the moving direction of each coil assumed when a current having the same polarity is applied to the voice coils 115A and 115B.

In this configuration, when an alternating current (AC) is applied to the voice coil 115A, the interaction between the AC and a magnetic flux passing through the gap 103A causes the cylindrical part 114A to reciprocate in axial direction. This causes the diaphragm to vibrate so that a sound is output. This operation also applies to a case where an AC is applied to the voice coil 115B.

According to this embodiment, the magnetic circuit 100 is shared by the speaker part 110A and the speaker part 110B thus allowing downsizing of the entire multi speaker unit. In this embodiment, in case it is necessary to deliver a high output from both the speaker part 110A and the speaker part 110B, it suffices to increase the size of the single magnetic circuit 100 alone. It is thus possible to reduce the increase in the size and weight of the entire apparatus that accompanies a high output.

### Second Embodiment

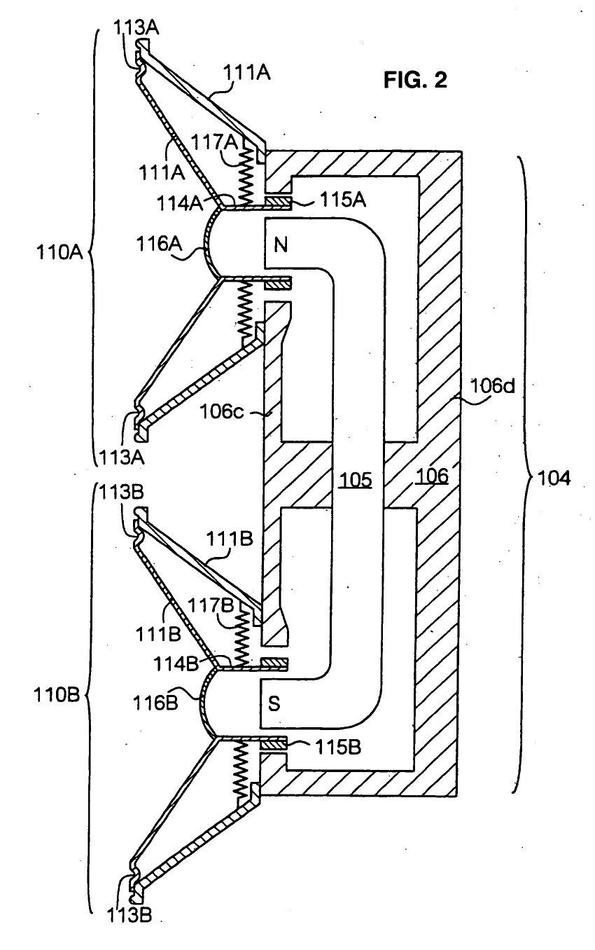

FIG. 2 is a cross-sectional view showing the configuration of a multi speaker unit according to a second embodiment of the invention. In FIG. 2, components corresponding to those shown in the first embodiment (FIG. 1) are given the same reference numbers and the related description is omitted. In the first embodiment, the two speaker parts 110A and 110B are oriented in directions opposite to each other. Two speaker parts 110A and 110B in this embodiment are adjacent while oriented in the same direction. The magnetic circuit 104 includes a permanent magnet 105 and a yoke 106. The permanent magnet 105 is bent at its both ends that are its north pole and south pole. The permanent magnet 105 is fixed to the yoke 106 in a state that the north pole is inserted into the voice coil 115A of the speaker part 110A and the south pole is inserted into the voice coil 115B of the speaker part 110B. The yoke 106 surrounds the permanent magnet 105. On one surface of the yoke 106 are provided two openings. In the gaps between these openings and the north and south poles of the permanent magnet 105 are arranged voice coils 115A and 115B. The yoke 106 has a portion 106c where the speaker parts 115A and 115B are located that is thinner than an opposite portion 106d. This is to match the magnetic reluctance of a magnetic path from the north pole of the permanent magnet 105 to the south pole through the portion 106c of the yoke 106 and that of a magnetic path from the north pole of the permanent magnet 105 to the south pole through the opposite portion 106d and to level the density of magnetic flux passing through the portions of the voice coil 115A and voice coil 115B in order to stabilize the vibration of the speaker part 110A and 110B.

This embodiment offers the same advantage according to the first embodiment.

### Third Embodiment

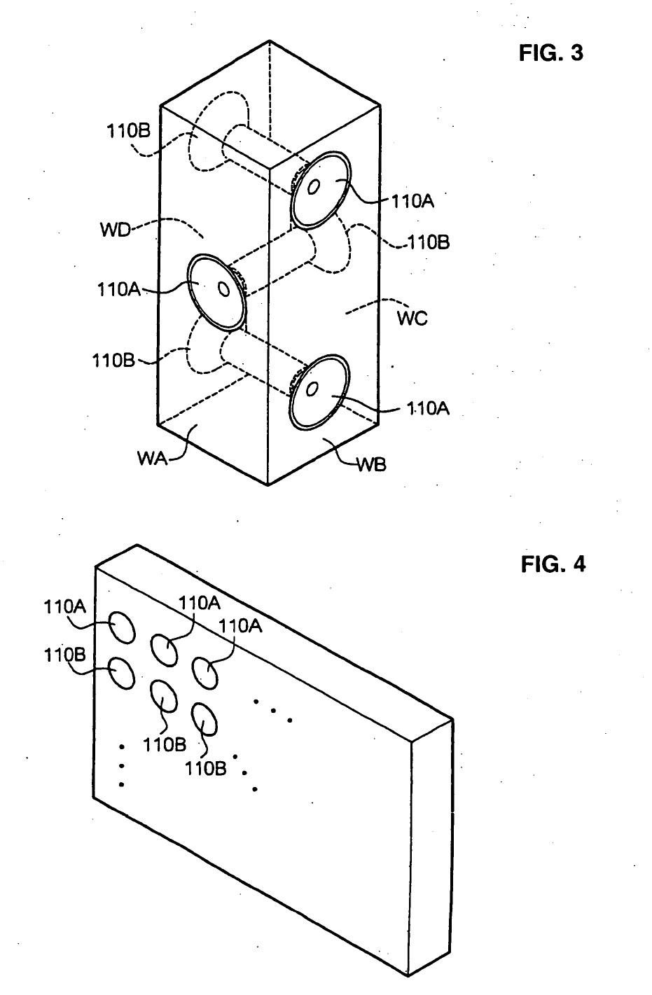

FIG. 3 is a perspective view showing the configuration of a multi speaker unit according to a third embodiment of the invention. The multi speaker unit in this embodiment includes a housing having shape of a rectangular solid accommodating a plurality of multi speaker units shown in the first embodiment. To be more precise, in this embodiment, the speaker parts 110A and 110B in the first embodiment are fixed to two side surfaces facing each other out of the four side surfaces of the housing WA, WB, WC and WD and the magnetic circuit 100 according to the first embodiment is accommodated in the housing (not shown).

This multi speaker unit outputs a sound around from speaker parts provided on each side of the housing. In this embodiment also, only a single magnetic circuit is required for two speaker parts thereby downsizing the entire multi speaker unit. Further, it is made easy to provide a high output from each speaker part.

### Fourth Embodiment

FIG. 4 is a perspective view of the configuration of a speaker array according to a fourth embodiment of the invention. As is well known, a speaker array is an audio reproduction apparatus including a plurality of speakers in a line, or in a plane as shown in FIG. 4 that is capable of outputting acoustic beams having a high directivity. This embodiment uses the multi speaker units of the second embodiment (FIG. 2) in the speaker array. In the example shown in FIG. 4, two speakers arranged vertically are multi speaker units in the second embodiment. The invention is not limited to this configuration but it is also possible to use multi speaker units in the second embodiment for two speakers arranged horizontally.

This embodiment offers the same advantage according to the foregoing embodiments.

### Fifth Embodiment

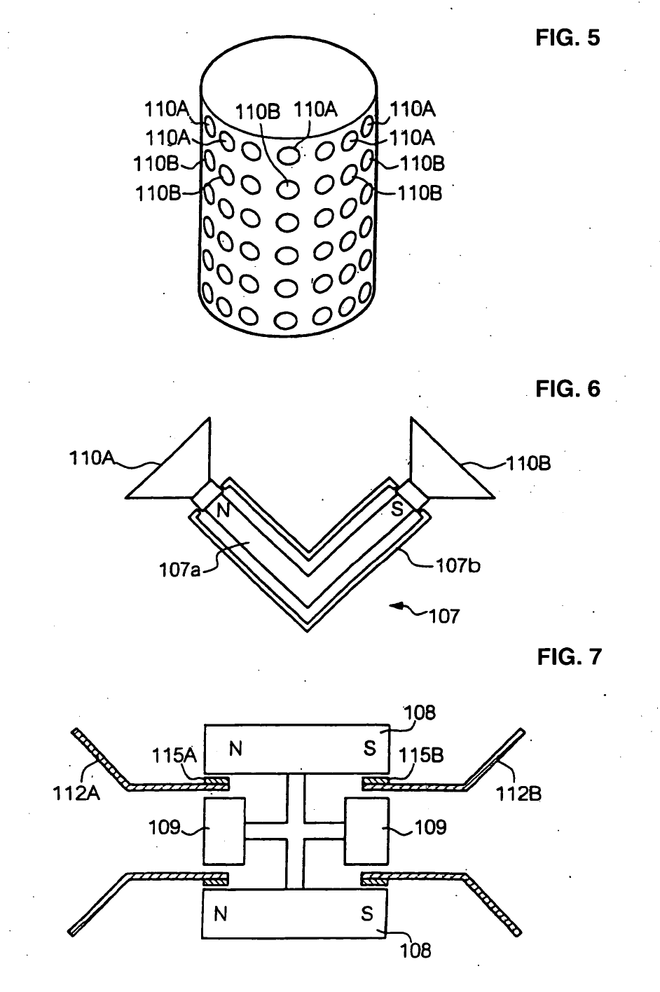

FIG. 5 is a perspective view of the configuration of a speaker array according to a fifth embodiment of the invention. While the speaker array in the fourth embodiment includes speakers arranged in a plane, the speaker array in the fifth embodiment arranges a plurality of speakers on the periphery of a cylinder capable of forming acoustic beams in any direction out of all directions around the cylinder. The fifth embodiment also uses a plurality of multi speaker units of the second embodiment (FIG. 2). In the example shown in FIG. 5, two speakers arranged vertically are multi speaker units in the second embodiment. The invention is not limited to this configuration but it is also possible to use multi speaker units in the second embodiment for two speakers arranged horizontally.

This embodiment offers the same advantage according to the foregoing embodiments.

### Other Embodiments

While embodiments of the invention have been described, other embodiments of the invention may be used:

(1) The speaker part 110A and the speaker part 110B in the first embodiment are oriented in directions opposite to each other. The speaker part 110A and the speaker part 110B in the second embodiment are oriented in the same direction. The directions of two speaker units 110A and 110B are not limited thereto. The example shown in FIG. 6 uses a magnetic circuit 107 which includes a permanent magnet 107a and a yoke 107b. The permanent magnet 107a is bent by 90 degrees and the yoke 107b surrounds the permanent magnet 107a. The speaker parts 110A and 110B has each magnetic pole of the permanent magnet inserted into each coil and are fixed to the magnetic circuit 107 with the speaker axes intersected by 90 degrees. In order to stabilize the vibration of the diaphragms of the speaker parts 110A and 110B, it is preferable to reduce the thickness of the inner portion of the L-shaped part of the yoke 107b compared with the thickness of the outer portion thereof so as to match the magnetic reluctance between the inside and outside.

(2) The permanent magnet is inside the yoke in the magnetic circuit according to the foregoing embodiments. The configuration of the magnetic circuit is not limited thereto. In the example shown in FIG. 7, a cylindrical yoke 109 having a stepped cylinder is provided inside a cylinder-shaped permanent magnet 108 and voice coils 105A and 105B are respectively arranged in the gaps between the yoke 109 and the magnetic poles of the permanent magnet 108. This embodiment offers the same advantage according to the foregoing embodiments.

The present application is based on Japan Patent Application No. 2005-120069 filed on Apr. 18, 2005, the contents of which are incorporated herein for reference.

What is claimed is:

1. A multi speaker unit, comprising:
a permanent magnet that has a north pole and a south pole;
a yoke that is opposed to the north pole and the south pole of the permanent magnet with first and second gaps;
a first voice coil that is arranged in the first gap between the north pole of the permanent magnet and the yoke;
a second voice coil that is arranged in the second gap between the south pole of the permanent magnet and the yoke; and
first and second vibrating parts that are fixed to the first and second voice coils respectively.

2. An audio reproduction apparatus, comprising a plurality of the multi speaker units according to claim 1.

3. The multi speaker unit as set forth in claim 1, wherein the first vibrating part is directed to a first direction opposite outward to a second direction to which the second vibrating part is directed.

4. The multi speaker unit as set forth in claim 1, wherein the first vibrating part and the second vibrating part are directed to the same direction.

5. An audio reproduction apparatus, comprising a plurality of the multi speaker units according to claim 3.

6. An audio reproduction apparatus, comprising:
a plurality of the multi speaker units according to claim 4,
wherein the multi speaker units are arranged on a plane.

7. An audio reproduction apparatus, comprising:
a plurality of the multi speaker units according to claim 4,
wherein the multi speaker units are arranged on a cylindrical face.

8. The multi speaker unit as set forth in claim 1, wherein the first vibrating part is directed to a first direction;
wherein the second vibrating part is directed to a second direction; and
wherein an angle formed by the first and second directions is substantially 90 degrees.

9. A multi speaker unit, comprising:
a permanent magnet that has a north pole and a south pole;
a yoke that is opposed to the north pole and the south pole of the permanent magnet with first and second gaps respectively;
a first voice coil that is arranged in the first gap between the north pole of the permanent magnet and the yoke;
a second voice coil that is arranged in the second gap between the south pole of the permanent magnet and the yoke; and
first and second vibrating parts that are fixed to the first and second voice coils respectively,
wherein the permanent magnet is formed in a tube shape; and
wherein the yoke is arranged inside the permanent magnet.
